(19) United States
(12) Patent Application Publication
(10) Pub. No.: US 2024/0246755 A1
(43) Pub. Date: Jul. 25, 2024

(54) HANGING TRASH RECEPTACLE

(71) Applicant: Inventor Gadgets LLC., Charlestown, RI (US)

(72) Inventor: Michael Nicholas DiMeo, Charlestown, RI (US)

(73) Assignee: Inventor Gadgets LLC., Charlestown, RI (US)

(21) Appl. No.: 18/418,820

(22) Filed: Jan. 22, 2024

Related U.S. Application Data
(60) Provisional application No. 63/481,537, filed on Jan. 25, 2023.

(51) Int. Cl. B65F 1/06

(52) U.S. Cl. CPC B65F 1/06; B65F 2001/061

(57) ABSTRACT

One or more hanging trash receptacles configured to be attached to a main trash container and further configured to receive pet waste and/or pet waste bags (also known as poop bags).

### CROSS-REFERENCE TO RELATED APPLICATIONS

This application claims priority to U.S. Provisional Application No. 63/481,537, filed Jan. 25, 2023, the entirety of which is incorporated by reference herein.

### BACKGROUND

Pet waste bags (also known as poop bags) tend to end up at the bottom of trash container. These pet waste bags can come from anywhere, they could be from a property owner's pets, a neighbor's pets, or from a passer-by who decides to drop their pet waste bag in an empty trash container sitting at the pavement. When the trash is added, the pet waste bags tend to get stuck at the bottom due to the added pressure. The stuck pet waste bags are difficult to remove: they will not drop off when the trash container is turned upside down to dump the trash using gravity; and, owing to the size of a typical trash container, it is very hard for a person to reach the bottom of the trash container and remove the pet waste bags. Furthermore, if at all possible, the business of removing pet poop plastered at a bottom of a trash container is inherently unpleasant. All of these are undesirable.

As such, a significant improvement in trash containers for better handling of pet waste bags is needed and desired.

### SUMMARY

Embodiments disclosed herein solve the aforementioned problems and may provide solutions to other problems as well. One or more embodiments disclosed herein provide a hanging trash receptacle that hangs from a main/larger trash container and is configured to receive pet waste bags comprising e.g., dog waste. In one or more embodiments, the disclosed hanging trash receptacle can hang inside or outside of the main trash container and is generally out of sight.

The hanging trash receptacle can be permanently mounted or removably attached to the main trash container. If permanently mounted, the shape (or contour) of the hanging trash receptacle is designed to be un-obtrusive to allow the main trash container to be lifted and dumped without the hanging trash receptacle being in the way of the trash falling out of the main trash container. If removably attached, the hanging trash receptacle can be easily removed before bringing out the main trash container to the street for collection.

In one or more embodiments, the disclosed hanging trash receptable may be attached or mounted to be swingable on the main trash container.

In one or more embodiments, a block is fitted within the bottom of the hanging receptacle. The block may keep any waste bags from becoming stuck in the narrowest part of the hanging receptacle.

In one or more embodiments, a hanging trash receptacle with a foldable, hollow opening may be provided. A small trash bag for pet waste can be secured within an unfolded (i.e., deployed) hollow opening, and pet waste can be deposited into the small trash bag. Once full, the small trash bag can be disposed of, and the hollow opening can be folded into a storage configuration.

### BRIEF DESCRIPTION OF THE DRAWINGS

FIG. 1 illustrates example hanging trash receptacle, according to the disclosed principles, attached to an inside of a main trash container.

FIG. 2 shows a side view of the FIG. 1 hanging trash receptacle according to the disclosed principles.

FIG. 3 shows another view of the FIG. 1 hanging trash receptacle according to the disclosed principles.

FIGS. 4A and 4B show an example hanging trash receptacle that is configured to swing on the main trash container according to the disclosed principles.

FIG. 5 shows another example hanging trash receptacle according to the disclosed principles.

FIGS. 6A-6E show a foldable hanging trash receptacle according to the disclosed principles.

### DETAILED DESCRIPTION

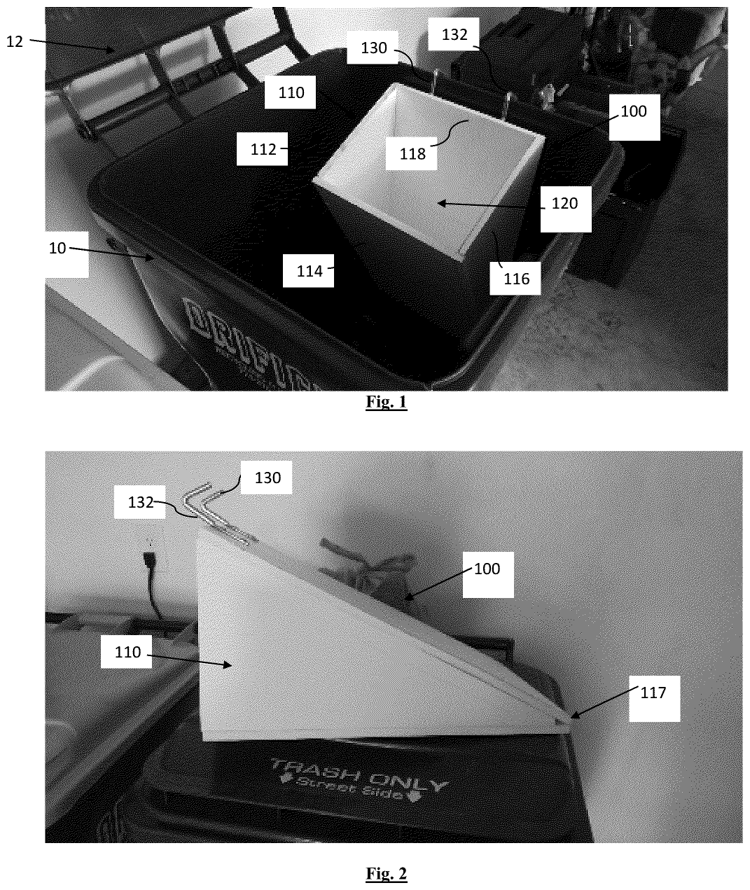

FIG. 1 shows an example hanging trash receptacle 100, according to the disclosed principles, inside a main trash container 10. In the illustrated embodiment, the hanging trash receptacle 100 has a body 110 with an opening 120 that is attached to hooks 130, 132. As shown, the body 110 has four side walls 112, 114, 116, 118, which connect to form a bottom portion 117 (FIG. 2). In one or more embodiments, the body 110 is made of a durable material such as e.g., wood or plastic.

It should be appreciated that the hanging trash receptacle 100 can be permanently mounted or removably attached to the main trash container 10 using any kind of mechanism and is not limited to the illustrated hooks 130, 132. It should also be appreciated that more or less hooks 130, 132 may be used. In one or more embodiments, the attachment mechanisms (e.g., hooks 130, 132) are made of metal (e.g., steel) and/or a corrosion resistant material such as e.g., aluminum or stainless steel. When the lid 12 of the main trash container 10 is closed, the hanging trash receptacle 100 is out of sight. Having the hanging trash receptacle 100 for e.g., receiving pet waste at the same location as the main trash container 10 is very convenient for the pet owner—all waste is at one central location.

FIG. 2 shows side view of the example hanging trash receptacle 100 based on the principles disclosed herein. As shown, the body 110 has a triangular shape, which may allow for, when the main trash container is being dumped, falling trash bags and other trash debris from getting caught or ripped by corners.

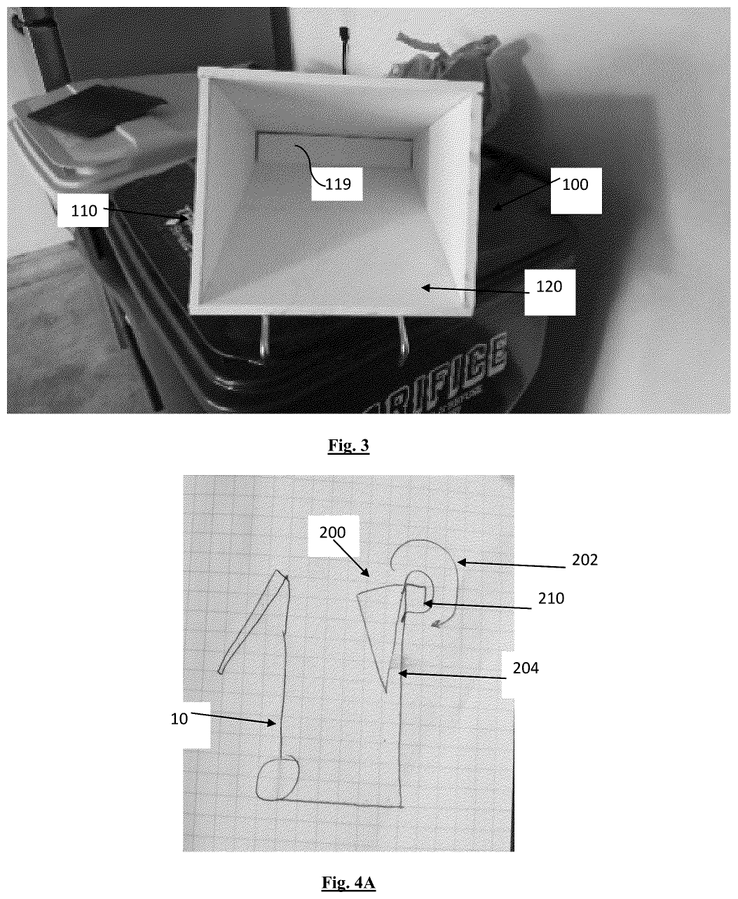

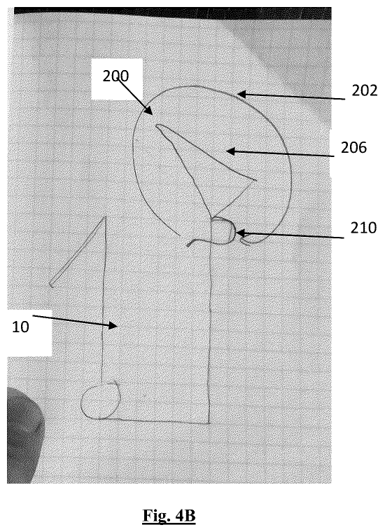

FIG. 3 shows a top view of an example hanging trash receptacle 100 based on the principles disclosed herein. As shown, a block 119 is fitted at the bottom portion 117, which is narrow (i.e., where the side walls 112, 114, 116, 118 meet at an edge) of the hanging trash receptacle 100 to create a flat interior bottom. The flat interior caused by the block 119 decreases the likelihood of the pet waste being plastered and the likelihood of the pet waste bag being stuck.

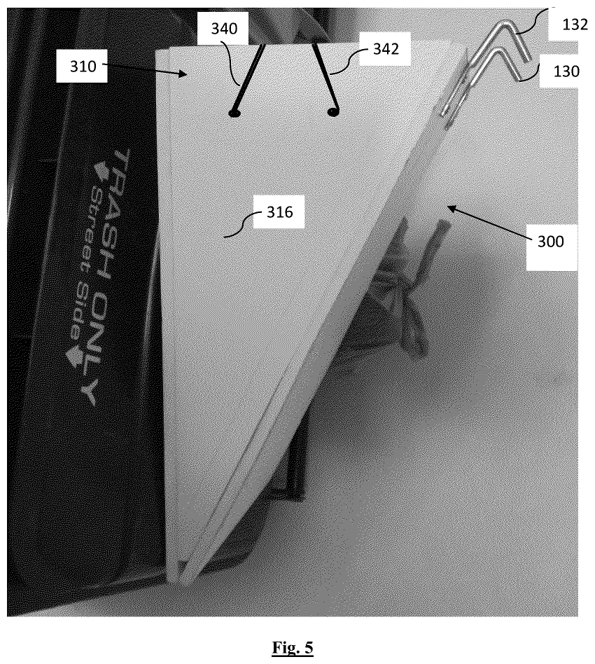

FIGS. 4A-4B show an example hanging trash receptacle 200 that is configured to swing on the main trash container 10. Particularly, FIG. 4A shows the hanging trash receptacle 200 and the main trash container 10 and the direction of the swing 202. In other words, FIG. 4A shows a rest condition 204, where the hanging trash receptacle 200 has not swung out. FIG. 4B shows a condition where the hanging trash receptacle 200 was swung out (referred to as the swung-out position 206) from the main trash container 10, while still being attached to it. This swinging out may occur when the main trash container 10 is being dumped, e.g., to a trash truck. As shown, the swinging out occurs around the attachment point 210 or attachment axis of the hanging trash receptacle 200 and the main trash container 10. With the exception of the modifications illustrated in FIGS. 4A and 4B, the hanging trash receptacle 200 may have the same or similar construction as the hanging trash receptacle 100 illustrated in FIG. 1.

FIG. 5 shows another example hanging trash receptacle 300 based on the principles disclosed herein. Particularly, the illustrated hanging trash receptacle 300 has a body 310 that includes cutouts 340, 342 in one or more walls 316. The cutouts 340, 342 can be used to attach small plastic bags to the hanging trash receptacle 300. For instance, one handle of a grocery bag can be slipped into the shown cutouts 340, 342 and another handle of the bag can be slipped into another cutout(s) on the other side (obscured from view) of the body 310. Using these cutouts 340, 342, the grocery bag can be kept open to receive pet waste or waste bags. Once the bag is full, the handles can be easily slipped out of the cutouts 340, 342, and the bag may be disposed. With the exception of the modifications illustrated in FIG. 5, the hanging trash receptacle 300 may have the same or similar construction as the hanging trash receptacle 100 illustrated in FIG. 1.

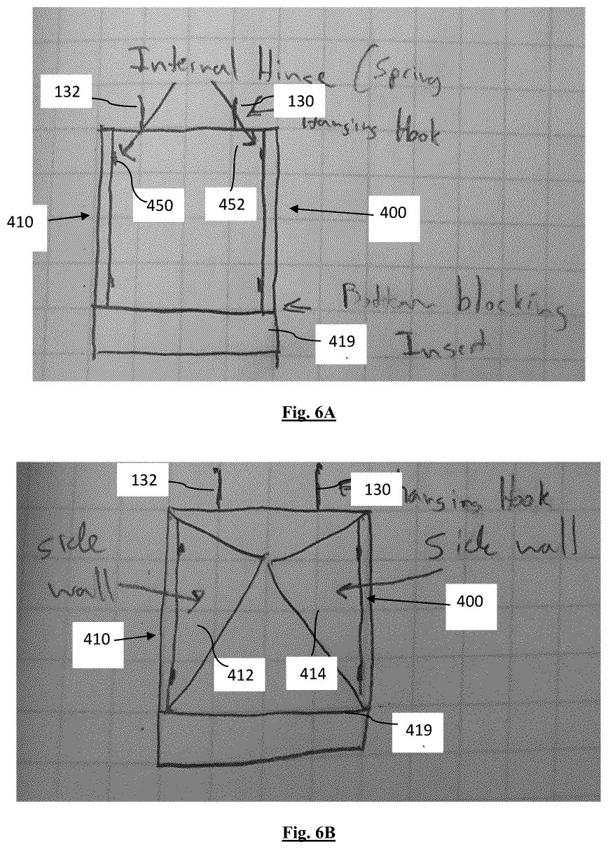

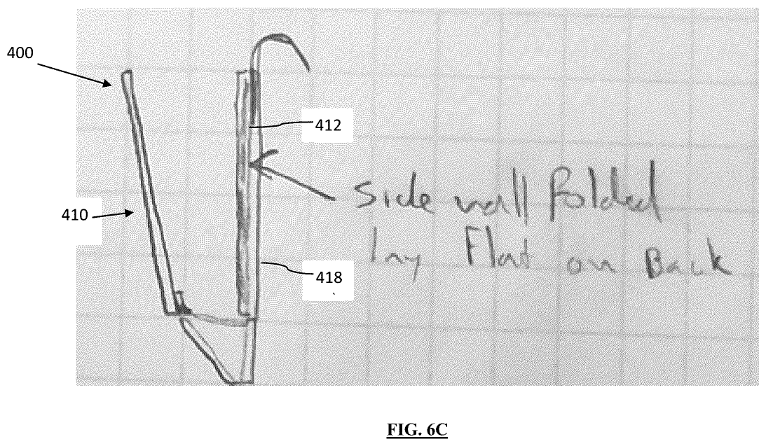

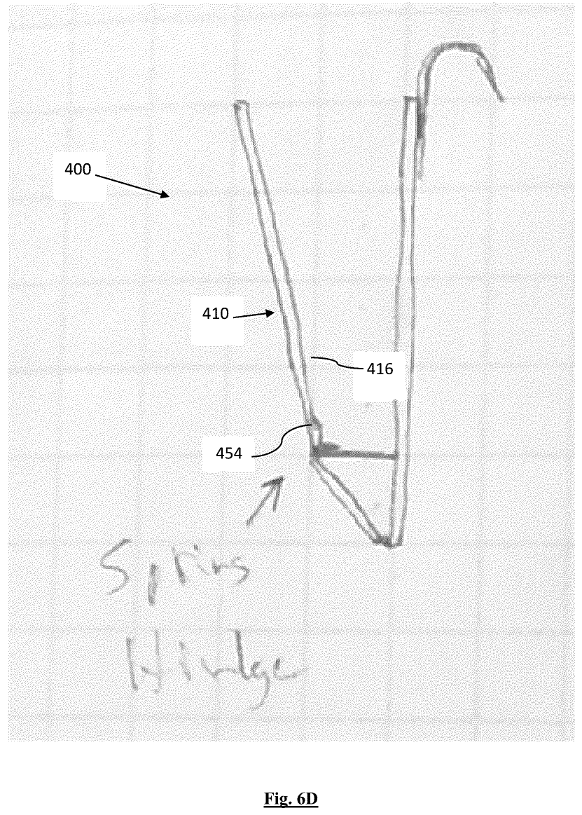

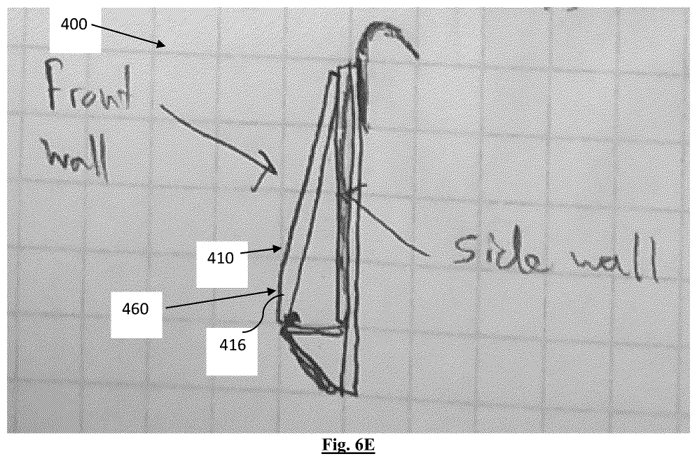

FIGS. 6A-6E show views of an example of a foldable hanging trash receptacle 400, based on the principles disclosed herein. Particularly, FIG. 6A shows a front view of the hanging trash receptacle 400 without showing the front wall of its body 410. The side will be on hinges 450, 452 (e.g., spring hinges) and fold in. For example, FIG. 6A shows two internal hinges 450, 452 for each side wall. The hinges 450, 452 may allow the side walls 412, 414 to fold in, for example, as shown in FIG. 6B. FIG. 6C shows a side view where a side wall 412 is folded in and lays flat on a back wall 418. Furthermore, as shown in FIG. 6D, the front wall 416 may also have one or more hinges (not shown), allowing for the front wall 416 to “fold in.” As further shown in FIG. 6D, the front wall 416 may have a spring hinge 454 that may pull the front wall to be pulled inward. To counteract the inward tensions from the springs, the front wall 416 may be beveled out, as shown in FIG. 6E. The beveled-out portion 460 may keep the trash receptacle open. However, when a force is applied to overcome the counteracting force provided by the beveled-out portion, the receptacle 400 may be collapsed (i.e., both side walls and the front wall fold and close in) to be in a storage/unused position.

It should be understood that the several designs and operations of the hanging trash receptacle shown and described above are just examples and should not be consider limiting. Any kind of design having the above-described functionality should be considered within the scope of this disclosure.

For example, in one or more embodiments, the hanging trash receptacle may be molded into main trash container such that the hanging trash receptacle and the main trash container form one unit. This design may allow for a smooth internal wall, preventing trash from being caught where the hanging trash receptacle and the main trash container would meet.

In one or more embodiments, the hanging trash receptacle may attach to the main trash receptacle by mechanism. Some non-limiting examples may include glue, screws, and or any other type of chemical or mechanical attachment mechanism.

The foregoing examples are provided merely for the purpose of explanation and are in no way to be construed as limiting. While reference to various embodiments is made, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and uses, such as are within the scope of the appended claims.

Additionally, the purpose of the Abstract is to enable the patent office and the public generally, and especially the scientists, engineers and practitioners in the art who are not familiar with patent or legal terms or phraseology, to determine quickly from a cursory inspection the nature of the technical disclosure of the application. The Abstract is not intended to be limiting as to the scope of the present inventions in any way.

What is claimed is:

1. A hanging trash receptacle configured to be attached to a main trash container and further configured to receive pet waste, said receptacle comprising:
a body portion having an opening; and
an attachment mechanism attached at a first end of the body and being configured to be attached to a portion of the main trash container.

2. The hanging trash receptacle of claim 1, wherein the attachment mechanism is configured to be removably attached to the main trash container.

3. The hanging trash receptacle of claim 1, wherein the attachment mechanism is configured to be permanently attached to the main trash container.

4. The hanging trash receptacle of claim 1, wherein the attachment mechanism is configured such that the body can swing about an attachment axis to the main trash container.

5. The hanging trash receptacle of claim 1, wherein the body comprises a shape configured to be unobtrusive to falling trash and trash debris when the trash is being dumped from the main trash container.

6. The hanging trash receptacle of claim 1, wherein the body comprises one or more cutouts configured to hold a handle portion of a bag.

7. The hanging trash receptacle of claim 1, wherein the body comprises walls configured to have an opening at a first end and configured to form a bottom at a second opposite end, the body further comprising a block located at the bottom to provide a flat bottom surface for the body.

8. The hanging trash receptacle of claim 1, wherein the body comprises side walls that are configured to folded in.

9. The hanging trash receptacle of claim 8, wherein the body comprises a front wall configured to be folded in.

10. The hanging trash receptacle of claim 9, wherein side walls of the body and the front wall are configured to be folded by spring tensions caused by springs formed on the body.

11. The hanging trash receptacle of claim 10, wherein the front wall comprises a beveled-out portion configured to counteract the spring tensions when the front wall and or the side walls are not folded in.

12. A hanging trash receptacle configured to be attached to a main trash container and further configured to receive pet waste, said receptacle comprising:
a body portion having an opening; and
a plurality of hooks attached to a first end of the body, said hooks being configured to be attached to the main trash container.

13. The hanging trash receptacle of claim 12, wherein the body comprises two side walls positioned between a front wall and a back wall, the walls forming a triangular shape of the body.

14. The hanging trash receptacle of claim 13, wherein a bottom portion of the body comprises a block forming a bottom surface of the bottom.

15. The hanging trash receptacle of claim 13, wherein one or more of the side walls of the body comprises one or more cutouts configured to hold a handle portion of a bag.

16. The hanging trash receptacle of claim 12, wherein the body comprises a front wall configured to be folded in.

17. The hanging trash receptacle of claim 16, wherein the front wall is configured to be folded by spring tensions caused by springs formed on the body.

18. The hanging trash receptacle of claim 17, wherein the front wall comprises a beveled-out portion configured to counteract the spring tensions when the front wall is not folded in.
